(19) United States
(12) Patent Application Publication
(10) Pub. No.: US 2013/0269799 A1
(43) Pub. Date: Oct. 17, 2013

(54) METHOD AND SYSTEM FOR USER NOTIFICATION

(71) Applicant: Jason Swist, Edmonton (CA)

(72) Inventor: Jason Swist, Edmonton (CA)

(21) Appl. No.: 13/444,919

(22) Filed: Apr. 12, 2012

(51) Int. Cl. F16K 37/00; B23P 17/00

(52) U.S. Cl. 137/551; 29/527.2

(57) ABSTRACT

Domestic uses of hot water are cooking, cleaning, bathing, and space heating. However, boiling water burns and even below 88° C. burns from hot water, commonly referred to as scalding, occur quickly in a matter of seconds. Even at lower temperatures whilst the time for burns increases for older people and children serious scalds can still occur due to disabilities or slow reaction times. Accordingly, embodiments of the invention provide visual indications of the temperature of water within a faucet or provide an in-line thermal restrictor.

### FIELD OF THE INVENTION

The present invention relates to plumbing and in particular to a method and system for notifying users of outlet water temperature.

### BACKGROUND OF THE INVENTION

Plumbing is the system of pipes and drains installed in a building for the distribution of potable (drinking) and non-potable water and the removal of waterborne wastes, and the skilled trade of working with pipes, tubing and plumbing fixtures in such systems. Plumbing typically involves discrete systems for hot water and cold water which are supplied to a variety of outlets disposed around a residential or commercial premise including faucets, taps, and shower heads.

Water heating is a thermodynamic process using an energy source to heat water above its initial temperature. Typical domestic uses of hot water are for cooking, cleaning, bathing, and space heating. Domestically, water is traditionally heated in vessels known as water heaters which heat a batch of water, but do not produce a continual supply of heated water at a preset temperature. The temperature will vary based on the consumption rate of hot water, use more and the water becomes cooler.

Appliances for providing a more-or-less constant supply of hot water are variously known as water heaters, hot water heaters, hot water tanks, boilers, heat exchangers, calorifiers, or geysers depending on whether they are heating potable or non-potable water, in domestic or industrial use, their energy source, and in which part of the world they are found. In domestic installations, potable water heated for uses other than space heating is sometimes known as domestic hot water (DHW). Typically these closed systems operate with some increase in pressure.

When the water temperature exceeds 100° C. (212° F.), the water will remain a liquid inside the tank, but when the pressure is released as the water comes out the tap the water will boil, potentially inflicting steam burns. Water above about 88° C. (190° F.) will cause burns on contact and some installations employ a temperature and pressure relief (T&P or TPR) valve in conjunction with the water heater to dump water if the temperature or pressure becomes too high under these circumstances. Other TPR valves may also stop further heating of the hot water within the water heater or systems may not employ TPR devices and exploit an expansion tank or exterior pressure relief valve to prevent pressure buildup.

However, even below 88° C. burns from hot water, commonly referred to as scalding, can occur quickly. Human skin burns quickly, as indicated in FIG. 2, at high water temperature in about 5 seconds at 60° C./140° F. resulting in second or third degree burns. At lower temperatures the time for burns increases but older people and children, as well as regular adults, can still receive serious scalds due to disabilities or slow reaction times. In some instances thermostatic valves are employed to mix enough cold water with the hot water from the heater to keep the outgoing water temperature fixed, for example often set to 50° C. Without such thermostatic valves a reduction of the water heater's set point temperature is the most direct way to reduce scalding. However, for sanitation, hot water is needed.

This is further exacerbated by two seemingly conflicting safety issues around water heater temperature, the first being the risk of scalding from excessively hot water greater than 55° C. (131° F.), and the second being the risk of incubating bacteria colonies, particularly Legionella, in water that is not hot enough to kill them. Both risks are potentially life threatening.

Even with thermostatic valves issues arise as they are mechanical devices subject to wear, erosion, corrosion, and failure from foreign particulates within the water flow etc. Issues may also arise even with functioning thermostatic valves if they are adjustable, such that they get adjusted accidentally or deliberately, that the user is sensitive such as with the elderly or children. Accordingly, today within the prior art there is nothing to indicate to the user of a faucet, tap, shower, etc. that the water they are about to use is hot and will cause burns, scalds, discomfort etc. The user's ability to determine this prior to placing their skin into the water is further exacerbated by decorative plumbing fixtures etc. which have external surfaces either with very poor thermal conductivity to internal pipes or specifically insulated from them such that the facet, for example, is cool whilst the water is scalding.

It would therefore be beneficial to provide the user with a quick, simple means of visually ascertaining the temperature of the water they have turned on.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate drawbacks of the prior art with respect to plumbing and in particular to a method and system for notifying users of outlet water temperature.

In accordance with an embodiment of the invention there is provided a device comprising:
an outer shell;
a water inlet for coupling to a source of water;
a valve operable between an open position and a closed position coupled to the water inlet and an outlet; and
a thermal conductor comprising a first predetermined portion disposed at least one of within and upon the outlet and a second predetermined portion coupled to an indicator disposed upon a predetermined portion of the outer shell; wherein
the indicator provides an indication to a user relating to the temperature of water flowing within the outlet.

In accordance with an embodiment of the invention there is provided a device comprising:
an outer shell;
a water inlet for coupling to a source of water;
a valve operable between an open position and a closed position coupled to the water inlet and an outlet;
a temperature sensor comprising a first predetermined portion disposed at least one of within and upon the outlet and a second predetermined portion coupled to an indicator disposed upon a predetermined portion of the outer shell; wherein
the indicator provides an indication to a user relating to the temperature of water flowing within the outlet.

In accordance with an embodiment of the invention there is provided a method comprising:
providing a thermally conductive block forming a predetermined portion of a plumbing device disposed between a predetermined portion of a pipe carrying water within a plumbing device and a predetermined portion of the outer body of the plumbing device, a predetermined portion of the thermally conductive block forming part of the outer surface of the plumbing device; and
providing a temperature dependent coating to a predetermined portion of that portion of the thermally conductive block forming part of the outer surface of the plumbing device.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts the temperature ranges for Legionella;

FIG. 2 depicts a temperature-time burn table for a typical adult male;

FIG. 3 depicts an example of an adjustable thermostatic valve according to the prior art;

FIG. 4 depicts a faucet according to an embodiment of the invention wherein the faucet and water pipe are a single element;

FIG. 5 depicts a faucet according to an embodiment of the invention wherein the faucet, water pipe, and user thermal control are separate elements within an assembly;

FIG. 6 depicts a faucet according to an embodiment of the invention wherein user temperature control is separate to the faucet which has the water pipe as a separate element to the faucet shell;

FIG. 7 depicts a thermal restrictor according to an embodiment of the invention;

FIG. 8 depicts a thermal restrictor according to an embodiment of the invention;

FIG. 9 depicts a thermal restrictor according to an embodiment of the invention; and

FIG. 10 depicts a thermal restrictor according to an embodiment of the invention exploiting memory retaining materials.

### DETAILED DESCRIPTION

The present invention is directed to plumbing and in particular to a method and system for notifying users of outlet water temperature.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

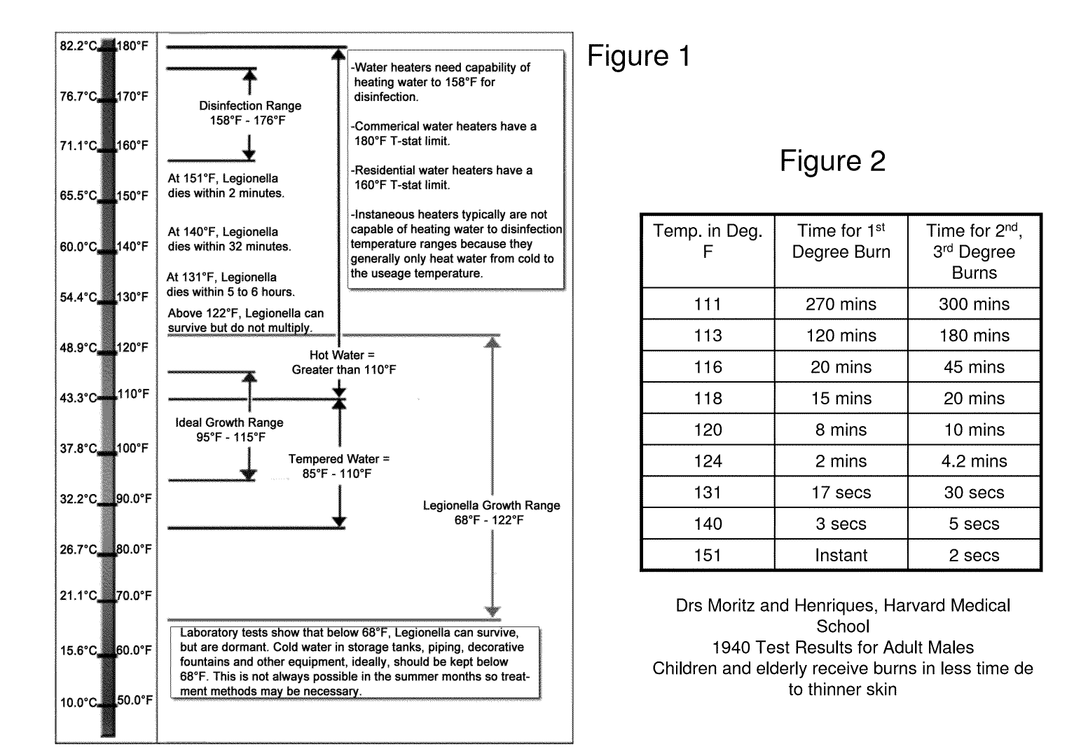

Referring to FIG. 1 there is depicted a chart with the temperature ranges for Legionella. As presented Legionella can grow between 68° F. and 122° F. although a narrower range of 95° F. and 115° F. represents a preferred growth range wherein tempered water, using a thermostatic valve, is typically between 85° F. and 110° F. Hot water is typically defined as being above 110° F. In terms of killing the Legionella bacteria then its survivability is typically less than 6 hours, 32 minutes, and 2 minutes when the water temperature is above 122° F., 131° F., and 151° F. respectively. Disinfection is typically achieved with water temperatures between 158° F. and 176° F. Considering, hot water heaters then instantaneous heaters cannot achieve disinfection as they generally only heat the water to the usage temperature. Residential and commercial water heaters typically have 160° F. and 180° F. upper temperature limits.

Now referring to FIG. 2 there is presented a temperature-burn chart for adult males as established by Harvard Medical School in the 1940s. Children, elderly, and women can burn faster from thinner skin. Referring to Table 1 below it is evident that even first degree burns are painful and take approximately a week to heal. As evident from FIG. 2 the time to a first degree burn is approximately 17 seconds at 131° F., 3 seconds at 140° F., and instantly at 151° F.

TABLE 1
Characteristics of Standard Burn Degree Classifications

| | | | Time to | |
|---|---|---|---|---|
| Nomenclature | Appearance | Sensation | healing | Complications |
| First degree | Redness (erythema) | Painful | 1 wk or less | None |
| Second degree | Red with clear | Painful | 2-3 wks | Local infection/cellulitis |
| (superficial partial | blister. Blanches | | | |
| thickness) | with pressure | | | |
| Second degree (deep | Red-and-white with | Painful | Weeks - may | Scarring, contractures |
| partial thickness) | bloody blisters. Less | | progress to | (may require excision and |
| | blanching. | | third degree | skin grafting) |
| Third degree (full | Stiff and | Painless | Requires | Scarring, contractures, |
| thickness) | white/brown | | excision | amputation |

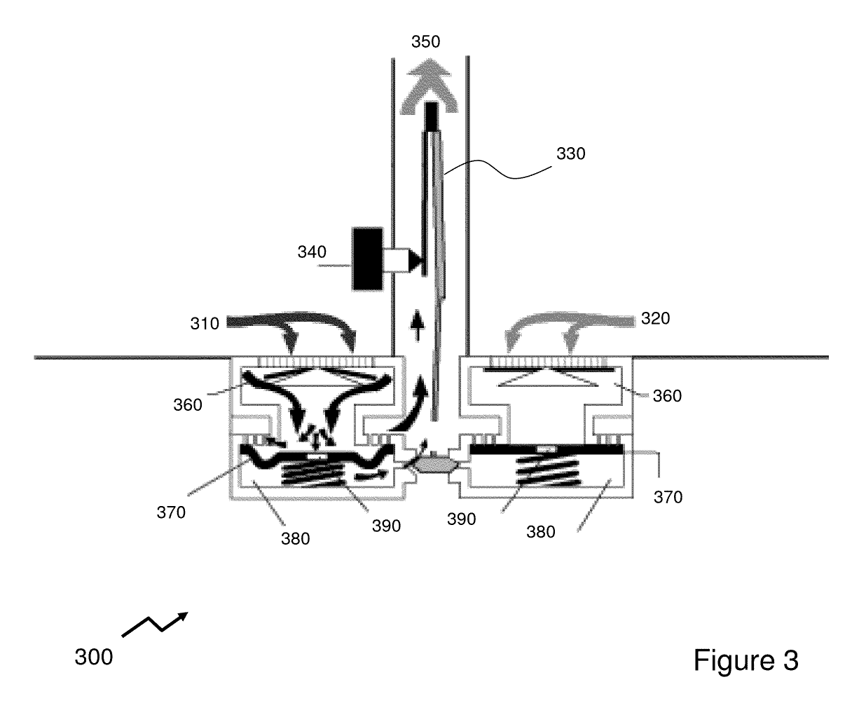

Now referring to FIG. 3 there is depicted an example of an adjustable thermostatic valve 300 according to the prior art. Accordingly the adjustable thermostatic valve 300 receives hot water 310 and cold water 320 to provide mixed water output 350. The adjustable thermostatic valve 300 includes an adjustment knob 340 allowing the set point of the adjustable thermostatic valve 300 to be set to different maximum temperatures for the mixed water output 350. The adjustment knob engages a bimetallic strip 330 which controls the action of one or other compression chamber 380 associated with the hot and cold water 310 and 320 respectively. The compression chamber 380 contains a jet 390 and membrane 380 that operate in conjunction with one another. Each side of the adjustable thermostatic valve 300 also includes non-return valves 360.

However, in the adjustable thermostatic valve 300 ingress of dirt, limescale, or other particulate matter may block one or other the jets 390 thereby causing the cold water side of the adjustable thermostatic valve 300 to fail such that only the hot water 310 passes to form the mixed water output 350. Similarly, chemicals within the hot water 310 or hot water 320 may cause the membrane 370 to change its properties, the bimetallic strip 330 may fail such that the output is only hot, or the adjustment knob 340 positioned to a setting stopping the bimetallic strip 330 operating or such that the output temperature setting is high enough to cause first degree burns or worse quickly. This is where such an adjustable thermostatic valve 300 has been installed.

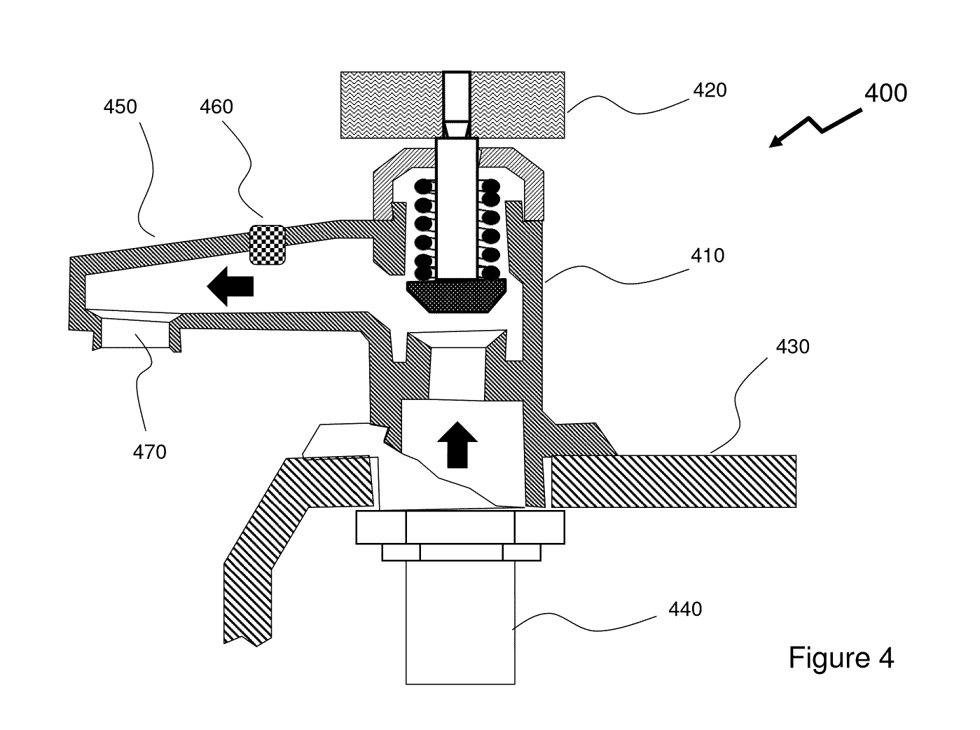

FIG. 4 depicts a faucet 400 according to an embodiment of the invention wherein the faucet and water pipe are a single element with an indicator element 460 providing a visual indication to the user of the water temperature. As depicted faucet 400 comprises handle 420, body 410, tap 450 with opening 470 and is attached to a surface 430, for example the upper surface of a cabinet or work surface, and is connected to inlet pipe 440. Accordingly, if the faucet 400 has not been used for a while the water within inlet pipe 440 will be cold and the user putting their hand into the water exiting the outlet 470 will be cold and then as they continue washing their hands etc the water becomes hotter until such point that they are scalded. Absent indicator element 460 the user has no inkling of this situation developing until it is too late and this is typically worse for the elderly and the young.

However, in the embodiment of the invention the indicator element 460 will present a change to the user as the water temperature increases. For example, the change may be passively established such as a change in color through use of an indicator material for example or visual appearance through use of an indicator dial for example. Alternatively the change may be actively established such as the turning on of a light or LED for example of the change in color of an optical source. Optionally the indication may be the emission of a sound either in respect of a warning once a predetermined temperature is reached or as a tone that adjust continuously with temperature. Optionally, one or more indicator means may be provided by indicator element 460 or multiple indicator elements 460 with different functions may be provided.

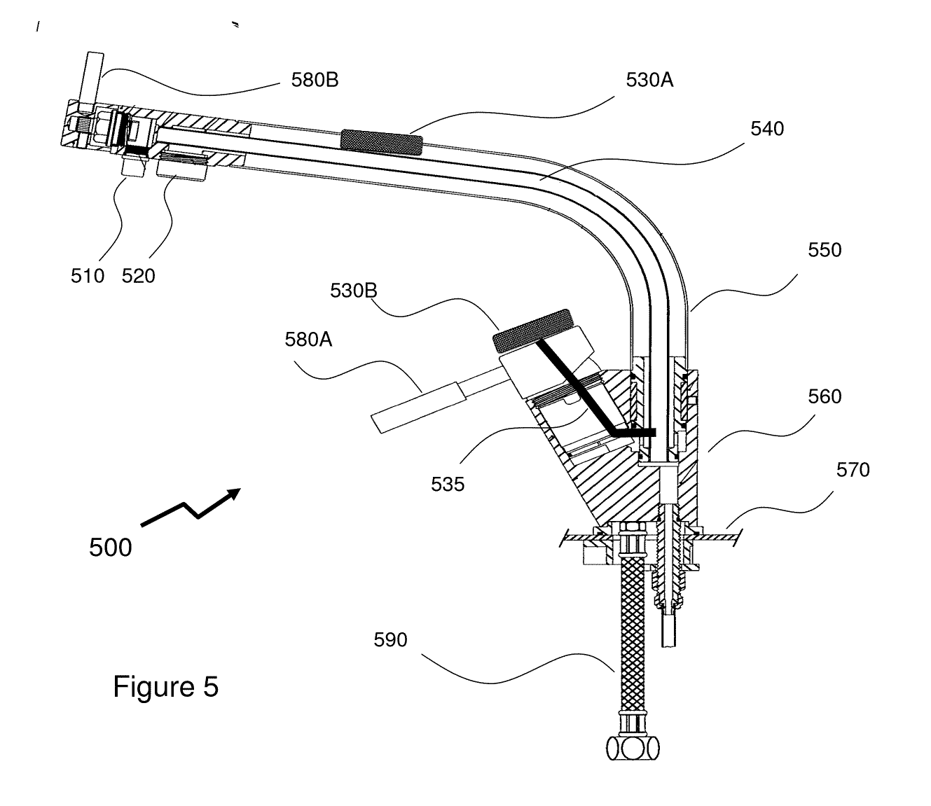

Now referring to FIG. 5 there is depicted a faucet 500 according to an embodiment of the invention wherein the faucet 550, water pipe 590, and user thermal control 580A are separate elements within an assembly that provides multiple indicators to the user, for example first and second indicators 530A and 530B respectively. As depicted faucet 500 receives water from a water supply via water pipe 590, of which only one is shown but within a mixer tap such as faucet 500 there would be one for hot and one for cold. In a non-mixer faucet there would be only one water pipe 590. Faucet 500 is mounted to surface 570 and comprises body 560, arm 550, and inner pipe 540 which terminates in opening 520 and nozzle 510 where operation of second lever 580B opens or shuts the nozzle 510.

Overall operation of faucet 500 is achieved through first lever 580A which for a mixer tap adjust the hot-cold water mix or with a single hot water feed the overall flow of the faucet 500. Within some faucets 500 the first lever 580A may control overall flow and hot-cold mix from the inlet pipes. Disposed within inner pipe 540 a sensor 535 provides a temperature coupling to second visual indicator 530B whilst first visual indicator 530A is similarly coupled to inner pipe 540. For example, sensor 535 may be a thermocouple such that second visual indicator 530B adjusts the visual indication provided to the user such as turning on an optical source or changing the color of an optical source for example. In contrast second visual indicator 530B is thermally coupled to the inner pipe 540 and provides a visual indication to the user that changes passively. Alternatively, second visual indicator 530B may be passive and first visual indicator 530A active, or both are passive, or both are active.

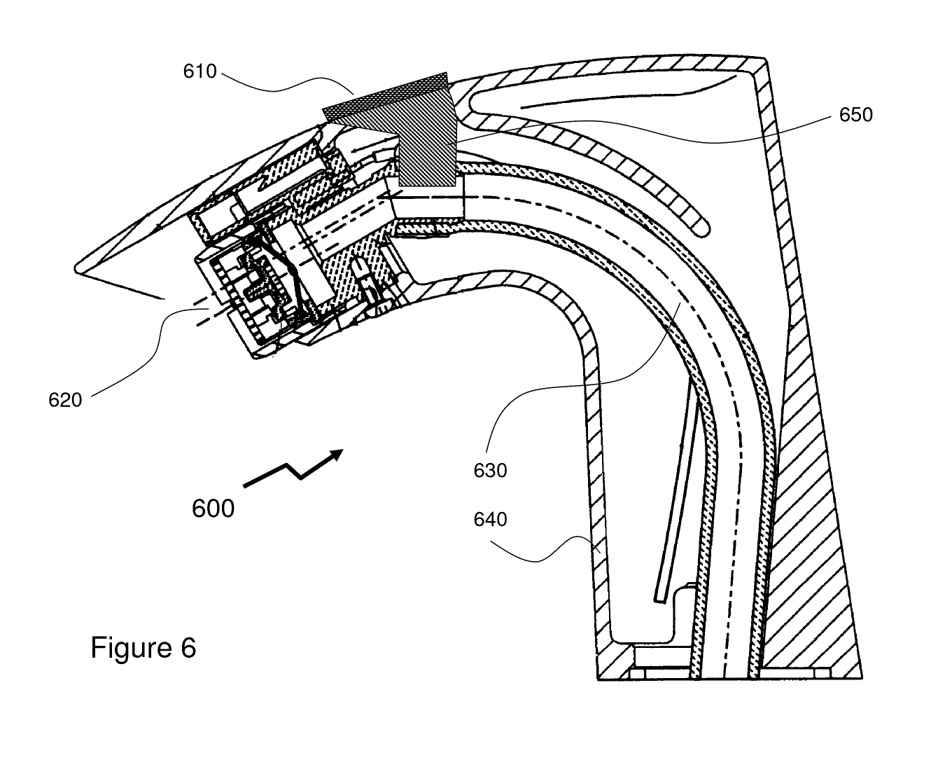

Referring to FIG. 6 there is depicted a faucet 600 according to an embodiment of the invention wherein user temperature control is separate to the faucet 600 which has the water pipe 630 as a separate element to the faucet shell 640. Faucet 600 also comprising nozzle 620 through which the water exits the faucet 600 and temperature block 650 which is coupled to inside of water pipe 630 thereby coupling the indicator element 610 to the temperature within the water pipe 640. In this case as faucet 600 is activated separately the user may not know what the temperature setting is such as for example in an automated system triggered by an optical sensor within the faucet 600 which turns on the water for a predetermined period of time or for as long as the optical sensor determines the user's body is present in front of the faucet 600.

Within the embodiments of the invention described above in respect of FIGS. 4 through 6 an element such as temperature block 650, sensor 535, first visual indicator 530A, and indicator element 460, provides a means of adjusting the indicator element according to the temperature of the water within the faucet or water pipe. The element may for example be a high conductivity material such as for example copper, copper tungsten, silver, artificial diamond, diamond, isotropically enriched diamond, and carbon nanotubes. It would be evident that high thermal conductivity provides for reduced delay between an increase in temperature of the water and the indication being provided to the user.

Alternatively, the element may be a thermocouple, such as for example a Type T (copper-constantan) thermocouple which is suited for measurements in the −200° C. to 350° C. range although others may be employed, a positive temperature coefficient thermistor, a negative temperature coefficient thermistor, or a semiconductor diode based device providing voltage dependent output, current dependent output or digital output. In some instances the semiconductor based device may be packaged in a manner allowing to be directly coupled to the water pipe itself or project within the water pipe.

The visual indicator as discussed above may be an LED for example that is turned on when the temperature exceeds a predetermined threshold, a multi-element LED that changes color such as from green to red, green to orange to red for example, or a numeric display. In these instances of active optical and/or acoustic indication the indicator element may be coupled to battery source for electrical power or alternatively the electrical mains.

In other instances the visual indication may be passively through the use of thermochromic materials such as liquid crystals and leuco dyes. Liquid crystals are typically used in precision applications, as their responses can be engineered to accurate temperatures, but their color range is limited by their principle of operation. Leuco dyes in contrast allow a wider range of colors to be used, but their response temperatures are more difficult to set with accuracy. Liquid crystals used in dyes and inks often come microencapsulated, in the form of suspension. Other materials may also be employed including for example thermochromic polymers and thermochromic pigments. Examples of thermochromic pigments include:
Cuprous mercury iodide (Cu2HgI4) which undergoes a phase transition at 55° C., reversibly changing from a bright red solid material at low temperature to a dark brown solid at high temperature, with intermediate red-purple states;
Silver mercury iodide (Ag2HgI4) is yellow at low temperatures and orange above 47-51° C., with intermediate yellow-orange states;
Bis(diethylammonium) tetrachlorocuprate is a bright green solid material, which at 52-53° C. reversibly changes color to yellow with no stable intermediate, the crystals are either green or yellow; and
Vanadium dioxide behaves like a semiconductor at lower temperatures, allowing more transmission, and like a conductor at higher temperatures, providing much greater reflectivity wherein the phase change between transparent semiconductive and reflective conductive phase occurs at 68° C. but doping the material with tungsten lowers the transition temperature, down to 29° C. with 1.9% tungsten.

Alternatively, the indicator means may be through a dial or numeric display. For example, a bimetallic strip coupled to the thermally conductive element or forming the thermally conductive element itself may drive a needle dial in response to the change in temperature or a thermocouple may provide the sensor input to a determination of temperature with a display such as 7-segment LEDs or LCD for example wherein the indicator may include an electrical control circuit, an electronic circuit, and a microprocessor.

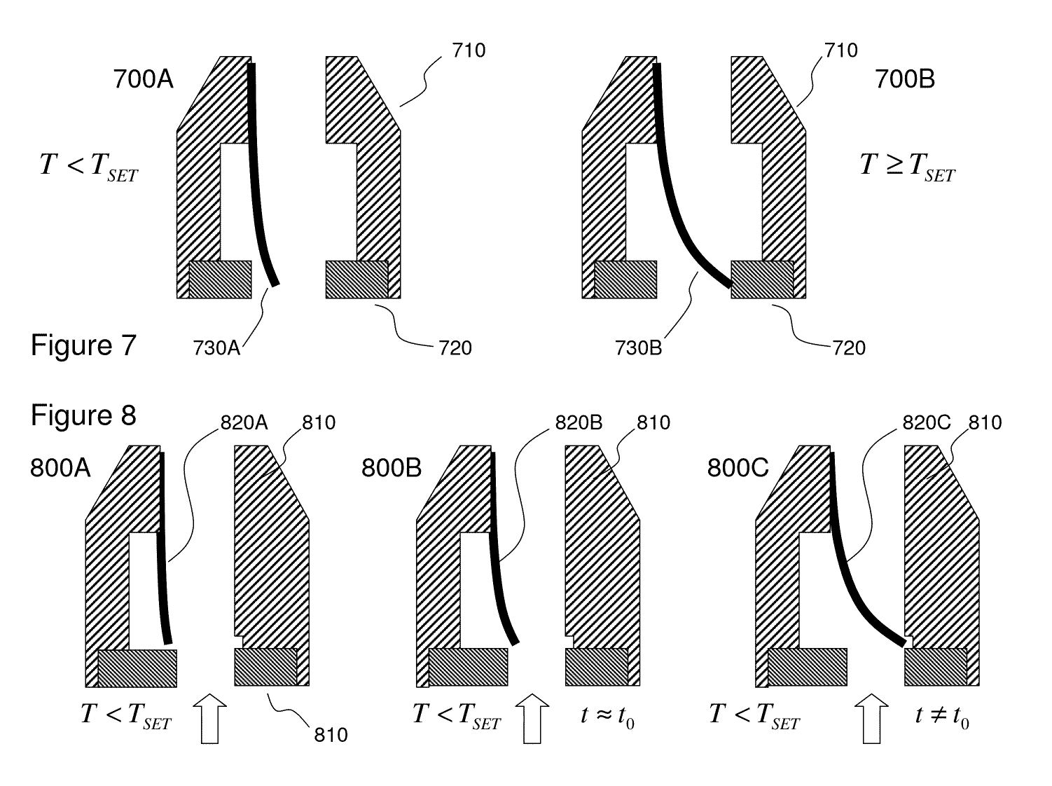

Referring to FIG. 7 there is depicted a thermal restrictor according to an embodiment of the invention in first and second states 700A and 700B representing operation below and above a predetermined cut-off temperature, T_{SET}. In first state 700A a body comprising shell 710 and outlet 720 is depicted with a thermal element in first configuration 730A disposed within the flow of water. In second state 700B the temperature of the water, T, has now risen to or above the predetermined cut-off temperature, T_{SET}, i.e. T≧T_{SET}. Accordingly, the thermal element is now in a second configuration 730B wherein it now blocks directly the flow of water through the outlet 720. Accordingly, the flow of hot water is now stopped whether the shell 710 and outlet 720 comprise part of a discrete faucet or a mixer faucet.

Now referring to FIG. 8 there is depicted a thermal restrictor according to an embodiment of the invention in first, second, and third states 800A through 800C respectively. In first state 800A a body comprising shell 810 and outlet 820 is depicted with a thermal element in first configuration 830A wherein it is not directly disposed within the flow of water. In second state 800B the temperature of the water, T, has now just risen to or above the predetermined cut-off temperature, T_{SET}, i.e. T≧T_{SET}. Accordingly, the thermal element is now in a second configuration 830B wherein it now just ingresses directly into the flow of water through the outlet 820. Accordingly, the pressure exerted by the water flowing through the outlet 820 now pushes the thermal element into a third configuration 830C wherein it is pushed against the opposite inner wall of the shell 810 thereby blocking the flow of water in third state 800C. Subsequently, for the thermal element to not block the outlet 820 the flow of water must be stopped or significantly reduced according to the design of the thermal element and the temperature drop to below T_{SET}.

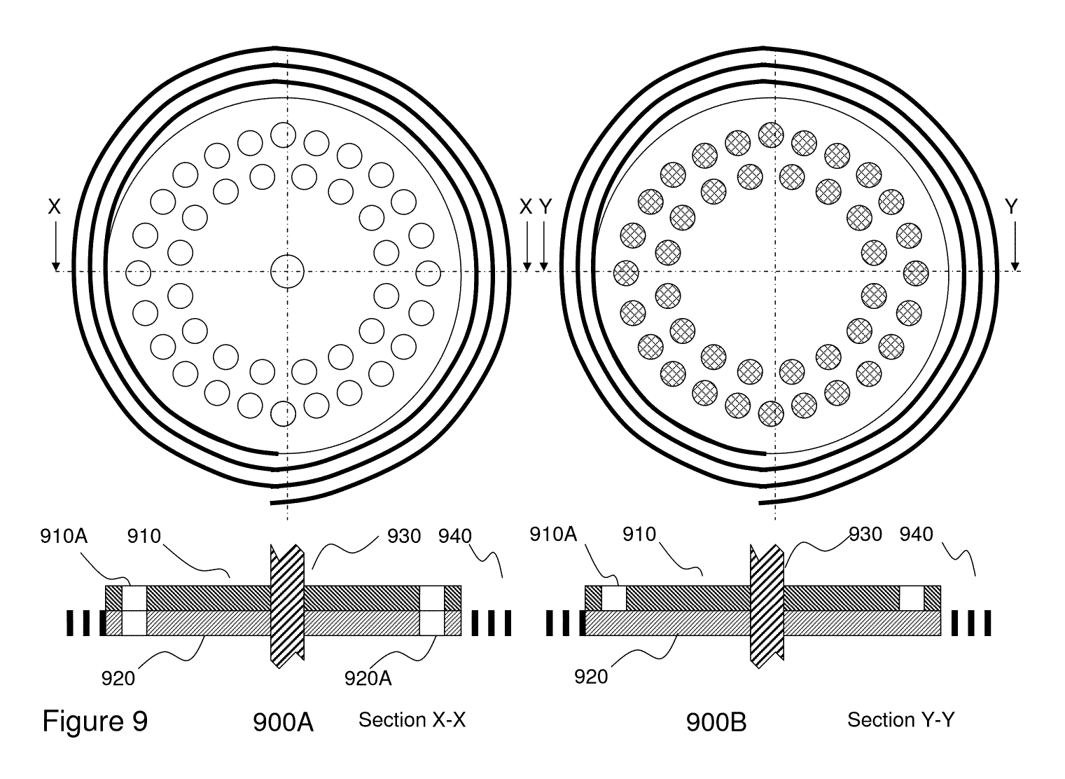

Referring to FIG. 9 there is depicted a thermal restrictor according to an embodiment of the invention wherein the thermal restrictor is depicted in first and second states 900A and 900B respectively. As depicted in first state 900A and corresponding cross-section X-X the thermal restrictor comprises upper plate 910 comprising a plurality of first holes 910A where the upper plate 910 rotates around a central mounting 930. The thermal restrictor further comprises a lower plate 920 comprising a plurality of second holes 920A similarly rotating around the same central mounting 930. Attached to a predetermined portion of the perimeter of lower plate 920 is expansion element 940. Accordingly an increase in temperature of the water flowing causes the expansion element 940 to expand thereby rotating the lower plate 920 relative to the upper plate 910 due to their common axis of rotation defined by central mounting 930.

At a predetermined temperature the lower plate 920 has rotated relative to the upper plate 910 such that the first holes 910A and second holes 920A are misaligned such that there is no communication from one side of the thermal restrictor to the other thereby cutting off the flow of hot water. If the lower plate 920 has second holes 920A that are smaller than first holes 910A in first plate 910 then the relative rotation of the two plates will initially not restrict the water flow until a first temperature is reached at which point the hot water flow would be increasingly restricted until the relative hole opening begins to close thereby limiting the flow of hot water.

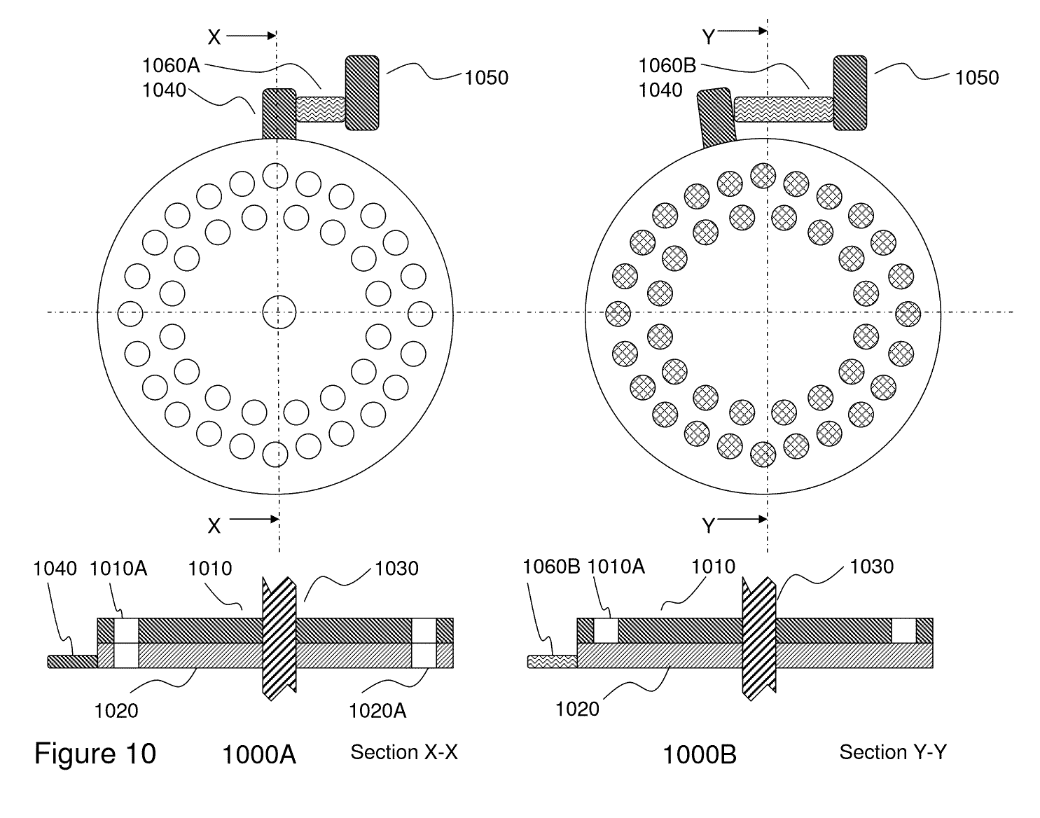

Now referring to FIG. 10 there is depicted a thermal restrictor according to an embodiment of the invention wherein the thermal restrictor is depicted in first and second states 1000A and 1000B respectively. As depicted in first state 1000A and corresponding cross-section X-X the thermal restrictor comprises upper plate 1010 comprising a plurality of first holes 1010A where the upper plate 1010 rotates around a central mounting 1030. The thermal restrictor further comprises a lower plate 1020 comprising a plurality of second holes 1020A similarly rotating around the same central mounting 1030. Attached to a predetermined portion of the perimeter of lower plate 1020 is a flange 1040 which is coupled to a memory expansion element that is depicted in deformed state 1060A between the flange 1040 and mount 1060. Accordingly an increase in temperature of the water flowing causes the memory expansion element to return from its deformed state 1060A to original state 1060B thereby causing a rotation in the lower plate 1020 relative to the upper plate 1010 due to their common axis of rotation defined by central mounting 1030. Upon reduction of temperature from the water flowing the memory expansion element does not return to the initial low temperature dimensions but rather requires that the memory expansion element be re-distorted, for example through mechanical action. Accordingly a push-button structure may engage the memory expansion element in a manner similar to that employed within ground circuit breakers for example.

As memory expansion element comprises a shape memory material such as nickel titanium, also known as nitinol, the memory expansion element returns to a pre-deformed straight shape, for example, from a deformed curved shape, for example when a predetermined temperature is exceeded wherein the temperature is determined from the alloy composition of the nickel and titanium. A variety of other shape material materials may be employed as alternatives to nitinol based upon a variety of factors including, but not limited to, manufacturability, temperature

Within the embodiments of the invention described above the thermal indication has been presented with respect to a faucet. It would be apparent to one skilled in the art that embodiments of the invention may be applied to other devices including but not limited to shower heads and shower controls. It would also be evident to one skilled in the art that the thermal indication may be set to provide the necessary visual or audible indication at a temperature below that causing a scald or burn.

It would be apparent to one skilled in the art that in some instances the user of a tap may require a thermal restrictor be temporarily “removed” from the flow so that water with a temperature in excess of the predetermined upper limit may be provided from the faucet etc. Accordingly, in some embodiments of the invention the mechanical thermal restrictor, such as described above in respect of FIGS. 7 through 10, may be bypassed or reset through a user action. For example in respect of FIGS. 9 and 10 a mechanical action by the user may temporarily space upper plates 910 and 1010 respectively and lower plates 920 and 1020 respectively apart such that hot water may still flow. Similarly in respect of FIGS. 7 and 8 a mechanical action may be provided to partially or fully open the flow by moving physically the thermal element. The mechanical pressure required for activation may be set at a level that young children or the infirm cannot provide thereby limiting actions by such population groups that are particularly prone to scalding.

In some instances activation of the “bypass” may be triggered through action of the user with an interface, e.g. button, touchscreen, fingerprint sensor, that subsequently triggers the mechanical motion to temporarily open the flow again. It would be evident that in some instances therefore logging of the user who triggered the bypass may be provided thereby addressing potential liability issues for the facility within which such a water outlet is provided. In such instances only authorised users would result in the temporary override. In each instance the duration of the override could be preset.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A device comprising:
an outer shell;
a water inlet for coupling to a source of water;
a valve operable between an open position and a closed position coupled to the water inlet and an outlet; and
a thermal conductor comprising a first predetermined portion disposed at least one of within and upon the outlet and a second predetermined portion coupled to an indicator disposed upon a predetermined portion of the outer shell; wherein
the indicator provides an indication to a user relating to the temperature of water flowing within the outlet.

2. The device according to claim 1 wherein,
the thermal conductor comprises at least one of a metal, a diamond, an isotropically modified diamond, and a carbon nanotube.

3. The device according to claim 1 wherein,
the indicator provides at least one of a colour change, a visual representation of the temperature, a reflectivity change, a visual signal, and an audible signal.

4. The device according to claim 1 wherein,
the indicator comprises at least one of a thermochromic ink, a thermochromic liquid crystal, a thermochromic polymer, a thermochromic pigment, and an LED.

5. The device according to claim 1 wherein,
the indicator generates an audible signal having a characteristic varying in dependence upon the temperature.

6. A device comprising:
an outer shell;
a water inlet for coupling to a source of water;
a valve operable between an open position and a closed position coupled to the water inlet and an outlet; and
a temperature sensor comprising a first predetermined portion disposed at least one of within and upon the outlet and a second predetermined portion coupled to an indicator disposed upon a predetermined portion of the outer shell; wherein
the indicator provides an indication to a user relating to the temperature of water flowing within the outlet.

7. The device according to claim 6 wherein,
the temperature sensor is at least one of a thermistor, a thermocouple, and a semiconductor diode.

8. The device according to claim 6 wherein,
the indicator provides at least one of a colour change, a visual representation of the temperature, a reflectivity change, a visual signal, and an audible signal.

9. The device according to claim 6 wherein,
the indicator generates an audible signal having a characteristic varying in dependence upon the temperature.

10. A method comprising;
providing a thermally conductive block forming a predetermined portion of a plumbing device disposed between a predetermined portion of a pipe carrying water within a plumbing device and a predetermined portion of the outer body of the plumbing device, a predetermined portion of the thermally conductive block forming part of the outer surface of the plumbing device; and
providing a temperature dependent coating to a predetermined portion of that portion of the thermally conductive block forming part of the outer surface of the plumbing device.

11. The method according to claim 10 wherein,
the temperature dependent coating comprises at least one of a thermochromic ink, a thermochromic liquid crystal, a thermochromic pigment, and a thermochromic polymer.

12. The method according to claim 10 wherein,
a predetermined portion of the thermally conductive block comprises at least one of a metal, a diamond, an isotropically modified diamond, and a carbon nanotube.

13. The method according to claim 10 wherein,
the temperature dependent coating provides at least one of a colour change and a reflectivity change.
